(19) United States
(12) Patent Application Publication
(10) Pub. No.: US 2020/0282448 A1
(43) Pub. Date: Sep. 10, 2020

(54) MANUFACTURING METHOD

(71) Applicant: ROLLS-ROYCE plc, London (GB)

(72) Inventors: Martin J. RAWSON, Derby (GB); Paul O. HILL, Derby (GB); Martin TUFFS, Nottingham (GB); Carl BOETTCHER, Derby (GB)

(73) Assignee: ROLLS-ROYCE plc, London (GB)

(21) Appl. No.: 16/810,007

(22) Filed: Mar. 5, 2020

(30) Foreign Application Priority Data
Mar. 5, 2019 (GB) 1902943.8

(51) Int. Cl. B21J 5/02; F02C 6/02

(52) U.S. Cl. CPC B21J 5/025; F02C 6/02; F05D 2230/25; F05D 2240/60; F05D 2220/32

(57) ABSTRACT

A method of manufacturing a component, the method including a maraging steel blank with an initial shape; and performing an incremental cold forming operation on the maraging steel blank, wherein the incremental cold forming operation reduces a thickness of the maraging steel blank.

### CROSS-REFERENCE TO RELATED APPLICATIONS

This specification is based upon and claims the benefit of priority from UK Patent Application Number 1902943.8 filed on 5 Mar. 2019, the entire contents of which are incorporated herein by reference.

### BACKGROUND

### Field of the Disclosure

The present disclosure relates to the field of manufacturing steel components, more particularly components for gas turbine engines.

### Description of the Related Art

Conventionally, certain gas turbine engine components, such as shafts, are manufactured by forging. However, the use of raw material in conventional forging methods may have disadvantages. For example, a quantity of excess material is typically wasted as machining swarf. In addition, with conventional forging, it may be difficult to control the austenite grain size prior to thermo-mechanical forging operations. This may lead to poor fatigue properties and/or poor temperature capabilities.

### SUMMARY

There are disclosed a method of manufacturing a component, a component, and a gas turbine engine as defined in the claims.

In one aspect of the disclosure, the method of manufacturing a component comprises providing a maraging steel blank with an initial shape; and performing an incremental cold forming operation on the maraging steel blank, wherein the incremental cold forming operation reduces a thickness of the maraging steel blank.

The incremental cold forming operation may be performed with the maraging steel blank at an initial temperature below the recrystallisation temperature of the maraging steel, optionally at room temperature.

The incremental cold forming operation may reduce the thickness of the maraging steel blank by at least 20%, optionally at least 40%, optionally at least 60%, optionally less than 80%, optionally less than 90%.

The incremental cold forming operation may comprise at least one of a flow-forming operation, a shear-forming operation, and a cold rotary forging operation.

The method may further comprise performing an age-hardening operation on the component after the incremental cold forming operation.

The age-hardening operation may be performed with the component at a temperature of at least 400éC, optionally at 540éC, optionally up to 600éC.

The age-hardening operation may be performed for a duration of between 3 to 25 hours, optionally for a duration of 10 hours.

Before performing the incremental cold forming operation, the initial shape of the maraging steel blank may be flat-shaped, cup-shaped, or tube-shaped.

In the above method, providing the maraging steel blank may comprise providing a maraging steel stock; and machining the maraging steel stock to the initial shape of the maraging steel blank.

The maraging steel stock may be a bar, a forging, a tube, a welded wrapper, or an extrusion.

In the above method, providing the maraging steel stock may comprise transforming the maraging steel of maraging steel stock into austenite by heating; and quenching the maraging steel stock to form a maraging steel microstructure comprising martensite.

In the above method, providing maraging steel blank may comprise transforming the maraging steel of maraging steel blank into austenite by heating; and quenching the maraging steel blank to form a maraging steel microstructure comprising martensite.

The quenching may be performed such that the maraging steel microstructure, before the incremental cold forming operation, comprises retained austenite.

In another aspect of the disclosure, there is disclosed a component manufactured using the above method.

In another aspect of the disclosure, there is disclosed a gas turbine engine for an aircraft comprising an engine core comprising a turbine, a compressor, and a core shaft connecting the turbine to the compressor; a fan located upstream of the engine core, the fan comprising a plurality of fan blades; and a gearbox that receives an input from the core shaft and outputs drive to the fan so as to drive the fan at a lower rotational speed than the core shaft, wherein the gas turbine engine comprises a component manufactured using the above method.

In the above gas turbine engine, the turbine may be a first turbine, the compressor may be a first compressor, and the core shaft may be a first core shaft; the engine core may further comprise a second turbine, a second compressor, and a second core shaft connecting the second turbine to the second compressor; and the second turbine, second compressor, and second core shaft may be arranged to rotate at a higher rotational speed than the first core shaft.

The core shaft may be manufactured using the above method.

One or both of the first and second core shafts may be manufactured using the above method.

As noted elsewhere herein, the present disclosure may relate to a gas turbine engine. Such a gas turbine engine may comprise an engine core comprising a turbine, a combustor, a compressor, and a core shaft connecting the turbine to the compressor. Such a gas turbine engine may comprise a fan (having fan blades) located upstream of the engine core.

Arrangements of the present disclosure may be particularly, although not exclusively, beneficial for fans that are driven via a gearbox. Accordingly, the gas turbine engine may comprise a gearbox that receives an input from the core shaft and outputs drive to the fan so as to drive the fan at a lower rotational speed than the core shaft. The input to the gearbox may be directly from the core shaft, or indirectly from the core shaft, for example via a spur shaft and/or gear. The core shaft may rigidly connect the turbine and the compressor, such that the turbine and compressor rotate at the same speed (with the fan rotating at a lower speed).

The gas turbine engine as described and/or claimed herein may have any suitable general architecture. For example, the gas turbine engine may have any desired number of shafts that connect turbines and compressors, for example one, two or three shafts. Purely by way of example, the turbine connected to the core shaft may be a first turbine, the compressor connected to the core shaft may be a first compressor, and the core shaft may be a first core shaft. The engine core may further comprise a second turbine, a second compressor, and a second core shaft connecting the second turbine to the second compressor. The second turbine, second compressor, and second core shaft may be arranged to rotate at a higher rotational speed than the first core shaft.

In such an arrangement, the second compressor may be positioned axially downstream of the first compressor. The second compressor may be arranged to receive (for example directly receive, for example via a generally annular duct) flow from the first compressor.

The gearbox may be arranged to be driven by the core shaft that is configured to rotate (for example in use) at the lowest rotational speed (for example the first core shaft in the example above). For example, the gearbox may be arranged to be driven only by the core shaft that is configured to rotate (for example in use) at the lowest rotational speed (for example only be the first core shaft, and not the second core shaft, in the example above). Alternatively, the gearbox may be arranged to be driven by any one or more shafts, for example the first and/or second shafts in the example above.

The gearbox may be a reduction gearbox (in that the output to the fan is a lower rotational rate than the input from the core shaft). Any type of gearbox may be used. For example, the gearbox may be a ‘planetary_ or ‘star_ gearbox, as described in more detail elsewhere herein. The gearbox may have any desired reduction ratio (defined as the rotational speed of the input shaft divided by the rotational speed of the output shaft), for example greater than 2.5, for example in the range of from 3 to 4.2, or 3.2 to 3.8, for example on the order of or at least 3, 3.1, 3.2, 3.3, 3.4, 3.5, 3.6, 3.7, 3.8, 3.9, 4, 4.1 or 4.2. The gear ratio may be, for example, between any two of the values in the previous sentence. Purely by way of example, the gearbox may be a ‘star_ gearbox having a ratio in the range of from 3.1 or 3.2 to 3.8. In some arrangements, the gear ratio may be outside these ranges.

In any gas turbine engine as described and/or claimed herein, a combustor may be provided axially downstream of the fan and compressor(s). For example, the combustor may be directly downstream of (for example at the exit of) the second compressor, where a second compressor is provided. By way of further example, the flow at the exit to the combustor may be provided to the inlet of the second turbine, where a second turbine is provided. The combustor may be provided upstream of the turbine(s).

The or each compressor (for example the first compressor and second compressor as described above) may comprise any number of stages, for example multiple stages. Each stage may comprise a row of rotor blades and a row of stator vanes, which may be variable stator vanes (in that their angle of incidence may be variable). The row of rotor blades and the row of stator vanes may be axially offset from each other.

The or each turbine (for example the first turbine and second turbine as described above) may comprise any number of stages, for example multiple stages. Each stage may comprise a row of rotor blades and a row of stator vanes. The row of rotor blades and the row of stator vanes may be axially offset from each other.

Each fan blade may be defined as having a radial span extending from a root (or hub) at a radially inner gas-washed location, or 0% span position, to a tip at a 100% span position. The ratio of the radius of the fan blade at the hub to the radius of the fan blade at the tip may be less than (or on the order of) any of: 0.4, 0.39, 0.38 0.37, 0.36, 0.35, 0.34, 0.33, 0.32, 0.31, 0.3, 0.29, 0.28, 0.27, 0.26, or 0.25. The ratio of the radius of the fan blade at the hub to the radius of the fan blade at the tip may be in an inclusive range bounded by any two of the values in the previous sentence (i.e. the values may form upper or lower bounds), for example in the range of from 0.28 to 0.32. These ratios may commonly be referred to as the hub-to-tip ratio. The radius at the hub and the radius at the tip may both be measured at the leading edge (or axially forwardmost) part of the blade. The hub-to-tip ratio refers, of course, to the gas-washed portion of the fan blade, i.e. the portion radially outside any platform.

The radius of the fan may be measured between the engine centreline and the tip of a fan blade at its leading edge. The fan diameter (which may simply be twice the radius of the fan) may be greater than (or on the order of) any of: 220 cm, 230 cm, 240 cm, 250 cm (around 100 inches), 260 cm, 270 cm (around 105 inches), 280 cm (around 110 inches), 290 cm (around 115 inches), 300 cm (around 120 inches), 310 cm, 320 cm (around 125 inches), 330 cm (around 130 inches), 340 cm (around 135 inches), 350 cm, 360 cm (around 140 inches), 370 cm (around 145 inches), 380 (around 150 inches) cm, 390 cm (around 155 inches), 400 cm, 410 cm (around 160 inches) or 420 cm (around 165 inches). The fan diameter may be in an inclusive range bounded by any two of the values in the previous sentence (i.e. the values may form upper or lower bounds), for example in the range of from 240 cm to 280 cm or 330 cm to 380 cm.

The rotational speed of the fan may vary in use. Generally, the rotational speed is lower for fans with a higher diameter. Purely by way of non-limitative example, the rotational speed of the fan at cruise conditions may be less than 2500 rpm, for example less than 2300 rpm. Purely by way of further non-limitative example, the rotational speed of the fan at cruise conditions for an engine having a fan diameter in the range of from 220 cm to 300 cm (for example 240 cm to 280 cm or 250 cm to 270 cm) may be in the range of from 1700 rpm to 2500 rpm, for example in the range of from 1800 rpm to 2300 rpm, for example in the range of from 1900 rpm to 2100 rpm. Purely by way of further non-limitative example, the rotational speed of the fan at cruise conditions for an engine having a fan diameter in the range of from 330 cm to 380 cm may be in the range of from 1200 rpm to 2000 rpm, for example in the range of from 1300 rpm to 1800 rpm, for example in the range of from 1400 rpm to 1800 rpm.

In use of the gas turbine engine, the fan (with associated fan blades) rotates about a rotational axis. This rotation results in the tip of the fan blade moving with a velocity Uₜᵢₚ. The work done by the fan blades 13 on the flow results in an enthalpy rise dH of the flow. A fan tip loading may be defined as dH/Uₜᵢₚ², where dH is the enthalpy rise (for example the 1-D average enthalpy rise) across the fan and Uₜᵢₚ is the (translational) velocity of the fan tip, for example at the leading edge of the tip (which may be defined as fan tip radius at leading edge multiplied by angular speed). The fan tip loading at cruise conditions may be greater than (or on the order of) any of: 0.28, 0.29, 0.30, 0.31, 0.32, 0.33, 0.34, 0.35, 0.36, 0.37, 0.38, 0.39 or 0.4 (all units in this paragraph being J kg⁻¹ K⁻¹/(ms⁻¹)²). The fan tip loading may be in an inclusive range bounded by any two of the values in the previous sentence (i.e. the values may form upper or lower bounds), for example in the range of from 0.28 to 0.31, or 0.29 to 0.3.

Gas turbine engines in accordance with the present disclosure may have any desired bypass ratio, where the bypass ratio is defined as the ratio of the mass flow rate of the flow through the bypass duct to the mass flow rate of the flow through the core at cruise conditions. In some arrangements the bypass ratio may be greater than (or on the order of) any of the following: 10, 10.5, 11, 11.5, 12, 12.5, 13, 13.5, 14, 14.5, 15, 15.5, 16, 16.5, 17, 17.5, 18, 18.5, 19, 19.5 or 20. The bypass ratio may be in an inclusive range bounded by any two of the values in the previous sentence (i.e. the values may form upper or lower bounds), for example in the range of form 12 to 16, 13 to 15, or 13 to 14. The bypass duct may be substantially annular. The bypass duct may be radially outside the core engine. The radially outer surface of the bypass duct may be defined by a nacelle and/or a fan case.

The overall pressure ratio of a gas turbine engine as described and/or claimed herein may be defined as the ratio of the stagnation pressure upstream of the fan to the stagnation pressure at the exit of the highest pressure compressor (before entry into the combustor). By way of non-limitative example, the overall pressure ratio of a gas turbine engine as described and/or claimed herein at cruise may be greater than (or on the order of) any of the following: 35, 40, 45, 50, 55, 60, 65, 70, 75. The overall pressure ratio may be in an inclusive range bounded by any two of the values in the previous sentence (i.e. the values may form upper or lower bounds), for example in the range of from 50 to 70.

Specific thrust of an engine may be defined as the net thrust of the engine divided by the total mass flow through the engine. At cruise conditions, the specific thrust of an engine described and/or claimed herein may be less than (or on the order of) any of the following: 110 Nkg⁻¹ s, 105 Nkg⁻¹ s, 100 Nkg⁻¹ s, 95 Nkg⁻¹ s, 90 Nkg⁻¹ s, 85 Nkg⁻¹ s or 80 Nkg⁻¹ s. The specific thrust may be in an inclusive range bounded by any two of the values in the previous sentence (i.e. the values may form upper or lower bounds), for example in the range of from 80 Nkg⁻¹ s to 100 Nkg⁻¹ s, or 85 Nkg⁻¹ s to 95 Nkg⁻¹ s. Such engines may be particularly efficient in comparison with conventional gas turbine engines.

A gas turbine engine as described and/or claimed herein may have any desired maximum thrust. Purely by way of non-limitative example, a gas turbine as described and/or claimed herein may be capable of producing a maximum thrust of at least (or on the order of) any of the following: 160 kN, 170 kN, 180 kN, 190 kN, 200 kN, 250 kN, 300 kN, 350 kN, 400 kN, 450 kN, 500 kN, or 550 kN. The maximum thrust may be in an inclusive range bounded by any two of the values in the previous sentence (i.e. the values may form upper or lower bounds). Purely by way of example, a gas turbine as described and/or claimed herein may be capable of producing a maximum thrust in the range of from 330 kN to 420 kN, for example 350 kN to 400 kN. The thrust referred to above may be the maximum net thrust at standard atmospheric conditions at sea level plus 15 degrees C. (ambient pressure 101.3 kPa, temperature 30 degrees C.), with the engine static.

In use, the temperature of the flow at the entry to the high pressure turbine may be particularly high. This temperature, which may be referred to as TET, may be measured at the exit to the combustor, for example immediately upstream of the first turbine vane, which itself may be referred to as a nozzle guide vane. At cruise, the TET may be at least (or on the order of) any of the following: 1400K, 1450K, 1500K, 1550K, 1600K or 1650K. The TET at cruise may be in an inclusive range bounded by any two of the values in the previous sentence (i.e. the values may form upper or lower bounds). The maximum TET in use of the engine may be, for example, at least (or on the order of) any of the following: 1700K, 1750K, 1800K, 1850K, 1900K, 1950K or 2000K. The maximum TET may be in an inclusive range bounded by any two of the values in the previous sentence (i.e. the values may form upper or lower bounds), for example in the range of from 1800K to 1950K. The maximum TET may occur, for example, at a high thrust condition, for example at a maximum take-off (MTO) condition.

A fan blade and/or aerofoil portion of a fan blade described and/or claimed herein may be manufactured from any suitable material or combination of materials. For example at least a part of the fan blade and/or aerofoil may be manufactured at least in part from a composite, for example a metal matrix composite and/or an organic matrix composite, such as carbon fibre. By way of further example at least a part of the fan blade and/or aerofoil may be manufactured at least in part from a metal, such as a titanium based metal or an aluminium based material (such as an aluminium-lithium alloy) or a steel based material. The fan blade may comprise at least two regions manufactured using different materials. For example, the fan blade may have a protective leading edge, which may be manufactured using a material that is better able to resist impact (for example from birds, ice or other material) than the rest of the blade. Such a leading edge may, for example, be manufactured using titanium or a titanium-based alloy. Thus, purely by way of example, the fan blade may have a carbon-fibre or aluminium based body (such as an aluminium lithium alloy) with a titanium leading edge.

A fan as described and/or claimed herein may comprise a central portion, from which the fan blades may extend, for example in a radial direction. The fan blades may be attached to the central portion in any desired manner. For example, each fan blade may comprise a fixture which may engage a corresponding slot in the hub (or disc). Purely by way of example, such a fixture may be in the form of a dovetail that may slot into and/or engage a corresponding slot in the hub/disc in order to fix the fan blade to the hub/disc. By way of further example, the fan blades maybe formed integrally with a central portion. Such an arrangement may be referred to as a bladed disc or a bladed ring. Any suitable method may be used to manufacture such a bladed disc or bladed ring. For example, at least a part of the fan blades may be machined from a block and/or at least part of the fan blades may be attached to the hub/disc by welding, such as linear friction welding.

The gas turbine engines described and/or claimed herein may or may not be provided with a variable area nozzle (VAN). Such a variable area nozzle may allow the exit area of the bypass duct to be varied in use. The general principles of the present disclosure may apply to engines with or without a VAN.

The fan of a gas turbine as described and/or claimed herein may have any desired number of fan blades, for example 14, 16, 18, 20, 22, 24 or 26 fan blades.

As used herein, cruise conditions may mean cruise conditions of an aircraft to which the gas turbine engine is attached. Such cruise conditions may be conventionally defined as the conditions at mid-cruise, for example the conditions experienced by the aircraft and/or engine at the midpoint (in terms of time and/or distance) between top of climb and start of decent.

Purely by way of example, the forward speed at the cruise condition may be any point in the range of from Mach 0.7 to 0.9, for example 0.75 to 0.85, for example 0.76 to 0.84, for example 0.77 to 0.83, for example 0.78 to 0.82, for example 0.79 to 0.81, for example on the order of Mach 0.8, on the order of Mach 0.85 or in the range of from 0.8 to 0.85. Any single speed within these ranges may be the cruise condition. For some aircraft, the cruise conditions may be outside these ranges, for example below Mach 0.7 or above Mach 0.9.

Purely by way of example, the cruise conditions may correspond to standard atmospheric conditions at an altitude that is in the range of from 10000 m to 15000 m, for example in the range of from 10000 m to 12000 m, for example in the range of from 10400 m to 11600 m (around 38000 ft), for example in the range of from 10500 m to 11500 m, for example in the range of from 10600 m to 11400 m, for example in the range of from 10700 m (around 35000 ft) to 11300 m, for example in the range of from 10800 m to 11200 m, for example in the range of from 10900 m to 11100 m, for example on the order of 11000 m. The cruise conditions may correspond to standard atmospheric conditions at any given altitude in these ranges.

Purely by way of example, the cruise conditions may correspond to: a forward Mach number of 0.8; a pressure of 23000 Pa; and a temperature of −55 degrees C. Purely by way of further example, the cruise conditions may correspond to: a forward Mach number of 0.85; a pressure of 24000 Pa; and a temperature of −54 degrees C. (which may be standard atmospheric conditions at 35000 ft).

As used anywhere herein, ‘cruise_or ‘cruise conditions_ may mean the aerodynamic design point. Such an aerodynamic design point (or ADP) may correspond to the conditions (comprising, for example, one or more of the Mach Number, environmental conditions and thrust requirement) for which the fan is designed to operate. This may mean, for example, the conditions at which the fan (or gas turbine engine) is designed to have optimum efficiency.

In use, a gas turbine engine described and/or claimed herein may operate at the cruise conditions defined elsewhere herein. Such cruise conditions may be determined by the cruise conditions (for example the mid-cruise conditions) of an aircraft to which at least one (for example 2 or 4) gas turbine engine may be mounted in order to provide propulsive thrust.

The skilled person will appreciate that except where mutually exclusive, a feature or parameter described in relation to any one of the above aspects may be applied to any other aspect. Furthermore, except where mutually exclusive, any feature or parameter described herein may be applied to any aspect and/or combined with any other feature or parameter described herein.

### BRIEF DESCRIPTION OF THE DRAWINGS

Embodiments will now be described by way of example only, with reference to the figures, in which:

FIG. 1 is a sectional side view of a gas turbine engine;

FIG. 2 is a close up sectional side view of an upstream portion of a gas turbine m engine;

FIG. 3 is a partially cut-away view of a gearbox for a gas turbine engine;

FIG. 4 depicts manufacturing a component;

FIG. 5 depicts providing a maraging steel blank;

FIG. 6 depicts providing a ma raging steel stock;

FIG. 7 depicts providing a maraging steel blank;

FIG. 8 depicts a flow-forming apparatus;

FIG. 9 shows stress-strain curves of a maraging steel using a conventional forging method and using flow-forming;

FIG. 10 is an optical image of a conventionally forged specimen of maraging steel, after age-hardening;

FIG. 11 is an optical image of a flow-formed specimen of maraging steel, after age-hardening;

FIG. 12 shows the amount of retained austenite in specimens; and

FIG. 13 shows the amount of retained austenite in specimens.

### DETAILED DESCRIPTION OF THE DISCLOSURE

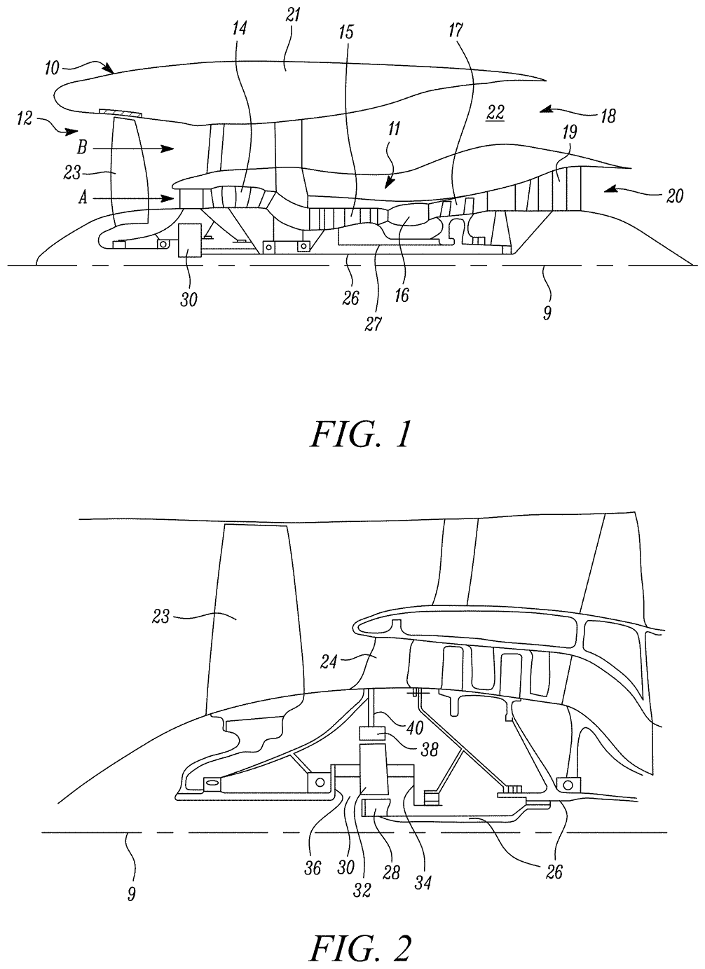

FIG. 1 illustrates a gas turbine engine 10 having a principal rotational axis 9. The engine 10 comprises an air intake 12 and a propulsive fan 23 that generates two airflows: a core airflow A and a bypass airflow B. The gas turbine engine 10 comprises a core 11 that receives the core airflow A. The engine core 11 comprises, in axial flow series, a low pressure compressor 14, a high-pressure compressor 15, combustion equipment 16, a high-pressure turbine 17, a low pressure turbine 19 and a core exhaust nozzle 20. A nacelle 21 surrounds the gas turbine engine 10 and defines a bypass duct 22 and a bypass exhaust nozzle 18. The bypass airflow B flows through the bypass duct 22. The fan 23 is attached to and driven by the low pressure turbine 19 via a shaft 26 and an epicyclic gearbox 30.

In use, the core airflow A is accelerated and compressed by the low pressure compressor 14 and directed into the high pressure compressor 15 where further compression takes place. The compressed air exhausted from the high pressure compressor 15 is directed into the combustion equipment 16 where it is mixed with fuel and the mixture is combusted. The resultant hot combustion products then expand through, and thereby drive, the high pressure and low pressure turbines 17, 19 before being exhausted through the nozzle 20 to provide some propulsive thrust. The high pressure turbine 17 drives the high pressure compressor 15 by a suitable interconnecting shaft 27. The fan 23 generally provides the majority of the propulsive thrust. The epicyclic gearbox 30 is a reduction gearbox.

An exemplary arrangement for a geared fan gas turbine engine 10 is shown in FIG. 2. The low pressure turbine 19 (see FIG. 1) drives the shaft 26, which is coupled to a sun wheel, or sun gear, 28 of the epicyclic gear arrangement 30. Radially outwardly of the sun gear 28 and intermeshing therewith is a plurality of planet gears 32 that are coupled together by a planet carrier 34. The planet carrier 34 constrains the planet gears 32 to precess around the sun gear 28 in synchronicity whilst enabling each planet gear 32 to rotate about its own axis. The planet carrier 34 is coupled via linkages 36 to the fan 23 in order to drive its rotation about the engine axis 9. Radially outwardly of the planet gears 32 and intermeshing therewith is an annulus or ring gear 38 that is coupled, via linkages 40, to a stationary supporting structure 24.

Note that the terms ‘low pressure turbine_ and ‘low pressure compressor_ as used herein may be taken to mean the lowest pressure turbine stages and lowest pressure compressor stages (i.e. not including the fan 23) respectively and/or the turbine and compressor stages that are connected together by the interconnecting shaft 26 with the lowest rotational speed in the engine (i.e. not including the gearbox output shaft that drives the fan 23). In some literature, the ‘low pressure turbine_ and ‘low pressure compressor_ referred to herein may alternatively be known as the ‘intermediate pressure turbine_ and ‘intermediate pressure compressor_. Where such alternative nomenclature is used, the fan 23 may be referred to as a first, or lowest pressure, compression stage.

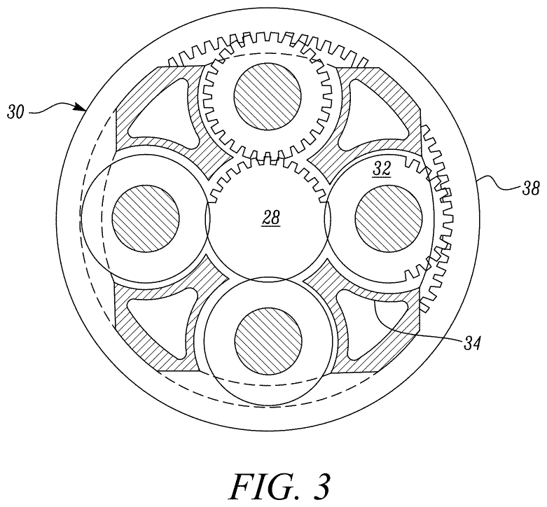

The epicyclic gearbox 30 is shown by way of example in greater detail in FIG. 3. Each of the sun gear 28, planet gears 32 and ring gear 38 comprise teeth about their periphery to intermesh with the other gears. However, for clarity only exemplary portions of the teeth are illustrated in FIG. 3. There are four planet gears 32 illustrated, although it will be apparent to the skilled reader that more or fewer planet gears 32 may be provided within the scope of the claimed invention. Practical applications of a planetary epicyclic gearbox 30 generally comprise at least three planet gears 32.

The epicyclic gearbox 30 illustrated by way of example in FIGS. 2 and 3 is of the planetary type, in that the planet carrier 34 is coupled to an output shaft via linkages 36, with the ring gear 38 fixed. However, any other suitable type of epicyclic gearbox 30 may be used. By way of further example, the epicyclic gearbox 30 may be a star arrangement, in which the planet carrier 34 is held fixed, with the ring (or annulus) gear 38 allowed to rotate. In such an arrangement the fan 23 is driven by the ring gear 38. By way of further alternative example, the gearbox 30 may be a differential gearbox in which the ring gear 38 and the planet carrier 34 are both allowed to 11, rotate.

It will be appreciated that the arrangement shown in FIGS. 2 and 3 is by way of example only, and various alternatives are within the scope of the present disclosure. Purely by way of example, any suitable arrangement may be used for locating the gearbox 30 in the engine 10 and/or for connecting the gearbox 30 to the engine 10. By way of further example, the connections (such as the linkages 36, 40 in the FIG. 2 example) between the gearbox 30 and other parts of the engine 10 (such as the input shaft 26, the output shaft and the fixed structure 24) may have any desired degree of stiffness or flexibility. By way of further example, any suitable arrangement of the bearings between rotating and stationary parts of the engine (for example between the input and output shafts from the gearbox and the fixed structures, such as the gearbox casing) may be used, and the disclosure is not limited to the exemplary arrangement of FIG. 2. For example, where the gearbox 30 has a star arrangement (described above), the skilled person would readily understand that the arrangement of output and support linkages and bearing locations would typically be different to that shown by way of example in FIG. 2.

Accordingly, the present disclosure extends to a gas turbine engine having any arrangement of gearbox styles (for example star or planetary), support structures, input and output shaft arrangement, and bearing locations.

Optionally, the gearbox may drive additional and/or alternative components (e.g. the intermediate pressure compressor and/or a booster compressor).

Other gas turbine engines to which the present disclosure may be applied may have alternative configurations. For example, such engines may have an alternative number of compressors and/or turbines and/or an alternative number of interconnecting shafts. By way of further example, the gas turbine engine shown in FIG. 1 has a split flow nozzle 18, 20 meaning that the flow through the bypass duct 22 has its own nozzle 18 that is separate to and radially outside the core engine nozzle 20. However, this is not limiting, and any aspect of the present disclosure may also apply to engines in which the flow through the bypass duct 22 and the flow through the core 11 are mixed, or combined, before (or upstream of) a single nozzle, which may be referred to as a mixed flow nozzle. One or both nozzles (whether mixed or split flow) may have a fixed or variable area. Whilst the described example relates to a turbofan engine, the disclosure may apply, for example, to any type of gas turbine engine, such as an open rotor (in which the fan stage is not surrounded by a nacelle) or turboprop engine, for example. In some arrangements, the gas turbine engine 10 may not comprise a gearbox 30.

The geometry of the gas turbine engine 10, and components thereof, is defined by a conventional axis system, comprising an axial direction (which is aligned with the rotational axis 9), a radial direction (in the bottom-to-top direction in FIG. 1), and a circumferential direction (perpendicular to the page in the FIG. 1 view). The axial, radial and circumferential directions are mutually perpendicular.

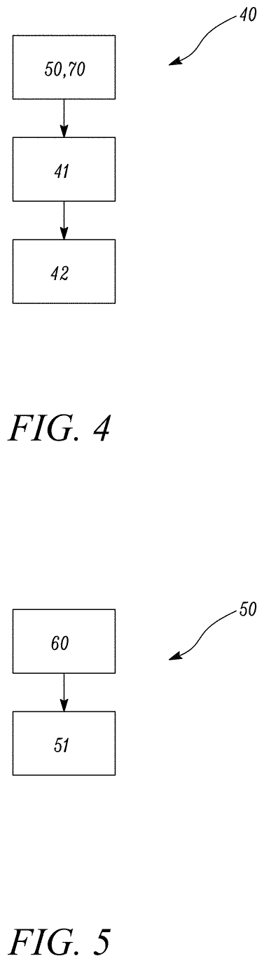

FIG. 4 depicts the steps of a method 40 of manufacturing a component, such as a shaft from a gas turbine engine. The method 40 comprises providing a maraging steel blank 50, 70, and performing an incremental cold forming operation 41 on the maraging steel blank. Before the incremental cold forming operation 41, the maraging steel blank may be provided with an initial shape. The incremental cold forming operation 41 may reduce a thickness of the maraging steel blank.

The incremental cold forming operation 41 may be performed with the maraging steel blank initially at a cold temperature. In this context, a cold temperature may be any temperature below the recrystallisation temperature of the maraging steel of the maraging steel blank. For example, the incremental cold forming 41 operation may be performed at room temperature. The incremental cold forming operation 41 may be performed without providing heat to the steel blank from an external source.

In general, the term ‘recrystallisation temperature_ refers to a temperature above which new and substantially dislocation-free grains emerge from a material that has been cold-worked. The precise value of the recrystallisation temperature depends on a number of factors, including the composition of the material and the extent of cold-work.

In the context of the present disclosure, the recrystallisation temperature may change during the course of the incremental cold forming operation 41 as a function of the extent of cold-work. The entirety of the incremental cold forming operation 41 may be performed with the maraging steel blank at a temperature below the recrystallisation temperature as defined locally in each portion of the maraging steel blank, and/or as defined temporally at each moment during the course of the incremental cold forming operation 41.

It may be desirable to ensure that the maraging steel blank remains below the recrystallisation temperature throughout the incremental cold forming operation 41. The initial temperature of the maraging steel blank may be far below the recrystallisation temperature. For example, the incremental cold forming operation 41 may be performed with the maraging steel blank initially at approximately 20éC, 30éC, 50éC, 100éC, 200éC, or 300éC. During the course of the incremental cold forming operation 41, the temperature of the maraging steel blank may be maintained approximately at the initial temperature, or may be allowed to vary, such as due to mechanical work or ambient cooling. During the incremental cold forming operation 41, the portion of the maraging steel blank undergoing deformation at a given time may rise in temperature due to applied mechanical work and friction. A coolant may be used to cool the maraging steel blank during the incremental cold forming operation 41 as necessary.

Alternatively, during the incremental cold forming operation 41, portions of the maraging steel of the maraging steel blank may be allowed reach, as a result of mechanical work and/or friction, a temperature approaching or exceeding the recrystallisation temperature. The temperature may exceed the recrystallisation temperature only slightly so that any recrystallisation is negligible or unobservable.

The incremental cold forming operation 41 (such as flow-forming) may be part of the thermo-mechanical history of the component.

The amount of reduction in thickness of the maraging steel blank resulting from the incremental cold forming operation 41 may vary depending on the initial shape of the maraging steel blank and the required shape of the component. For example, the thickness reduction may be at least 20%, at least 40%, or at least 60%. The thickness reduction may be less than 80%, less than 85%, or less than 90%.

The term ‘incremental cold forming_ is used to refer to any manufacturing process which is carried out initially at a temperature below the recrystallization temperature, which gradually shapes the workpiece whilst reducing its thickness through plastic deformation, and which causes the plastic deformation substantially purely by compressive forces. This is in contrast with other manufacturing processes such as spinning, which involves a combination of compressive and tensile forces and does not substantially reduce the thickness of the workpiece. As noted above, during incremental cold forming, the workpiece may be kept at a temperature below the recrystallisation temperature, or may be allowed to reach a temperature approaching or exceeding the recrystallisation temperature slightly as a result of mechanical work.

Compared with conventional forging methods, incremental cold forming may improve the efficiency in the use of raw materials. For example, in conventional forging, excess material may be wasted as machining swarf.

Examples of incremental cold forming include flow-forming, shear-forming, and cold rotary forging. The incremental cold forming operation 41 may include at least one of these operations. It will be understood that the incremental cold forming operation 41 may comprise a sequence of these operations as required to achieve a particular shape.

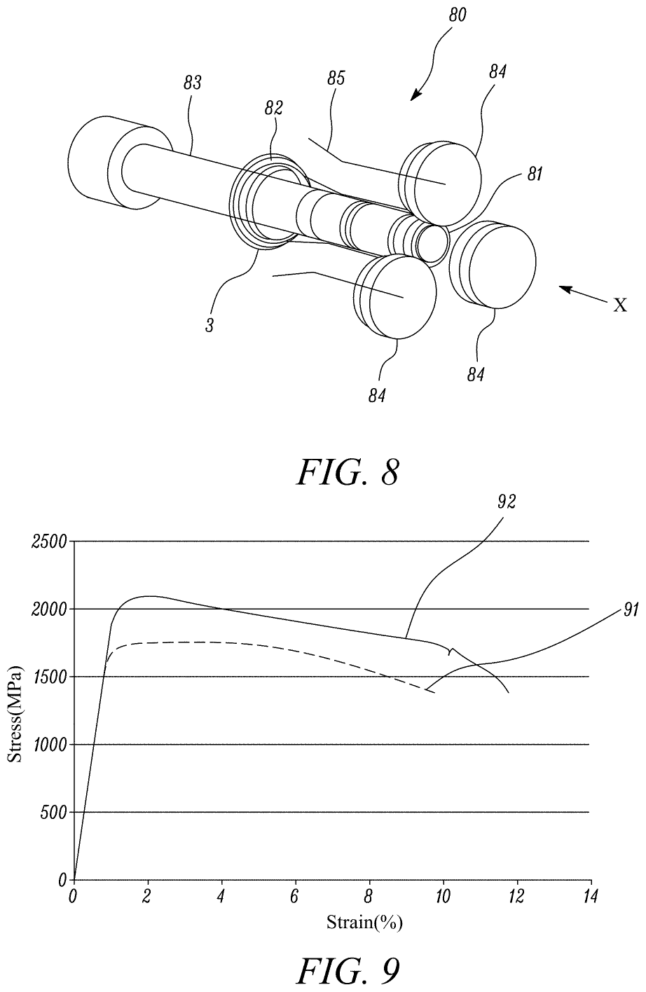

By way of an example, FIG. 8 shows a schematic of a flow-forming apparatus 80. A blank 81, which may be cup-shaped or tube-shaped, may be installed onto a mandrel 83. One or more rollers 84 may exert a compressive force onto the blank 81, which force may be counterbalanced by a reaction force from the mandrel 83. As the mandrel 83 rotates together with the blank 81, the compressive force may cause the blank 81 to deform and reduce in thickness. The one or more rollers 84 may move along trajectory 85, which may be substantially parallel to the axis of rotation of the mandrel 83, thereby deforming a portion of the blank which has not reached its final dimensions 82. The one or more rollers 84 may deform the blank 81 over a number of passes, each pass having a slightly different trajectory 85 in order to cause a small deformation, until the required shape is achieved. The blank 81 may thus be formed incrementally to produce the component. In this example, the component is a hollow, cylindrically symmetrical part. The component may be near net shape (i.e. near the final required shape of the component) after flow-forming. After flow-forming, further machining may not be necessary, although conventional machining may be applied if desired.

Other incremental cold forming methods, such as those mentioned above, may also be capable of producing near net shape components. Further machining may be applied if desired.

As shown in FIG. 4, the method may also include an age-hardening operation 42 on the component after the incremental cold forming operation 41.

The age-hardening operation 42 may be performed with the component at a temperature of about 500éC, or less than 510éC. This may be necessary if a conventional maraging steel is used, which has limited age-hardenability due to a high level of nickel, which is an austenite stabiliser. At higher temperatures, austenite reversion may begin, which may reduce the strength of the maraging steel.

The age-hardening operation 42 may alternatively be performed with the component at a temperature of at least 450éC, at least 500éC, at least 550éC, or up to 600éC. For example, the age-hardening operation 42 may be performed at about 540éC to 580éC. The age-hardening operation 42 may be performed at about 540éC. At these temperatures, maraging steels with lower levels of nickel may be required in order to prevent or limit austenite reversion. Even higher temperatures may be used. However, excessively high temperatures may result in a small reduction in strength.

The age-hardening operation 42 may last several hours. For example, the age-hardening operation 42 may last about 3 hours, about 6 hours, about 9 hours, about 12 hours, about 15 hours, about 18 hours, about 21 hours, about 24 hours, or up to 25 hours. The age-hardening operation 42 may last about 10 hours. The duration of the age-hardening operation 42 may be determined or adjusted based on a number of factors, such as the age-hardening temperature, the geometry of the component, the extent of cold-work resulting from the incremental cold forming operation 41, the composition of the maraging steel, or the desired metallurgical properties.

A number of compositions of maraging steels are known. For example, ASTM A579/A579M, revision 17a, gives maraging steel compositions under Grades 71, 72, 73, 74 and 75. MIL-S-46850, revision D, gives maraging steel compositions under Grades 200, 250, 300 and 350. These known maraging steels may be used with the present disclosure.

Maraging steel compositions suitable for use with the present invention with lower levels of nickel may include (by mass) ‘Alloy 2_ as disclosed in US 2012/080124 A1: 5-9% nickel, 8-12% chromium, 7-10% cobalt, 2-3% tungsten, 2-4% molybdenum, 1-2.5% aluminium, 0-0.01% titanium, the balance being iron and unavoidable impurities. US 2012/080124 A1 also discloses the relevant parameters for using such an alloy, including suitable austenitisation temperatures, age-hardening temperatures and durations, and service temperatures.

A specific maraging steel composition may be (by mass): 9% nickel, 8.97% chromium, 8.57% cobalt, 2.08% tungsten, 2.02% molybdenum, 1.83% aluminium, 0.004% titanium, optionally 0.01% copper, optionally 0.02% silicon, optionally 0.01% manganese, optionally 0.002% niobium, optionally 0.003% boron, optionally 0.002% nitrogen, optionally 0.003% phosphorous, optionally 0.003% sulphur, and optionally 0.004% tin, and optionally 0.003% carbon, the balance being iron and unavoidable impurities.

Another specific maraging steel composition may be (by mass): 8.95% nickel, 8.84% chromium, 8.38% cobalt, 2.05% tungsten, 1.99% molybdenum, 1.68% aluminium, optionally 0.03% copper, optionally less than 0.01% silicon, optionally less than 0.01% manganese, optionally 0.004% boron, optionally less than 0.002% nitrogen, optionally less than 0.005% phosphorous, optionally less than 0.003% sulphur, optionally less than 0.01% tin, and optionally less than 0.01% carbon, the balance being iron and unavoidable impurities.

Another specific maraging steel composition may be (by mass): 9% nickel, 9% chromium, 8.56% cobalt, 2.08% tungsten, 2.06% molybdenum, 1.68% aluminium, 0.004% titanium, optionally 0.01% copper, optionally 0.02% silicon, optionally 0.01% manganese, optionally 0.003% niobium, optionally 0.0026% boron, optionally 0.001% nitrogen, optionally 0.002% phosphorous, optionally 0.003% sulphur, optionally less than 0.001% tin, optionally 0.003% tantalum, and optionally 0.008% carbon, the balance being iron and unavoidable impurities.

Another specific maraging steel composition may be (by mass): 8.98% nickel, 8.99% chromium, 8.54% cobalt, 2.09% tungsten, 2.04% molybdenum, 1.68% aluminium, 0.004% titanium, optionally 0.01% copper, optionally 0.02% silicon, optionally 0.01% manganese, optionally 0.003% niobium, optionally 0.0025% boron, optionally 0.001% nitrogen, optionally 0.002% phosphorous, optionally 0.003% sulphur, optionally less than 0.001% tin, optionally 0.003% tantalum, optionally 0.007% carbon, the balance being iron and unavoidable impurities.

During age-hardening, intermetallic compounds may form in the microstructure of the maraging steel. The intermetallic compounds may have high hardness. The intermetallic compounds may serve as suitable dispersions within the microstructure to achieve high temperature strength. The strength of the maraging steel may be improved by a modification of the distribution of intermetallic compounds. This modification may be achieved as a result of the incremental cold forming operation 41.

The combination of the use of maraging steel and an incremental cold forming operation 41 may modify the structure and properties of the maraging steel. For example, the reduction in thickness of the maraging steel blank during the incremental cold forming operation 41 may promote a fine grain size in the microstructure of the maraging steel. A refined grain size may improve the strength of the material. The increase in strength may be due to Hall-Petch strengthening. The use of incremental cold forming on maraging steels may result in a slower crack growth rate compared with conventional forging. Parameters of the incremental cold forming operation 41 may be selected to enhance the grain size refinement in the microstructure of the maraging steel. A refined grain size, combined with age-hardening, may further improve the properties of the maraging steel. In conventional thermo-mechanical forging methods, it may be difficult to control the austenite grain size prior to forging, which may result in poor fatigue properties of the final component.

FIG. 9 shows the stress-strain curves of two specimens. Curve 91 shows the behaviour of a specimen of a maraging steel with a lower level of nickel, as disclosed above. The specimen of curve 91 is conventionally forged. Curve 92 shows the behaviour of a specimen of the same maraging steel as that of curve 91, but the specimen is flow-formed instead of conventionally forged. As shown in the Figure, curve 92 represents a greater yield stress and greater ultimate tensile strength than curve 91. Curve 92 also shows no reduction in ductility compared with curve 91. Therefore, when a component of maraging steel is formed by flow-forming, strength may be increased compared with conventional forging, and ductility may be maintained.

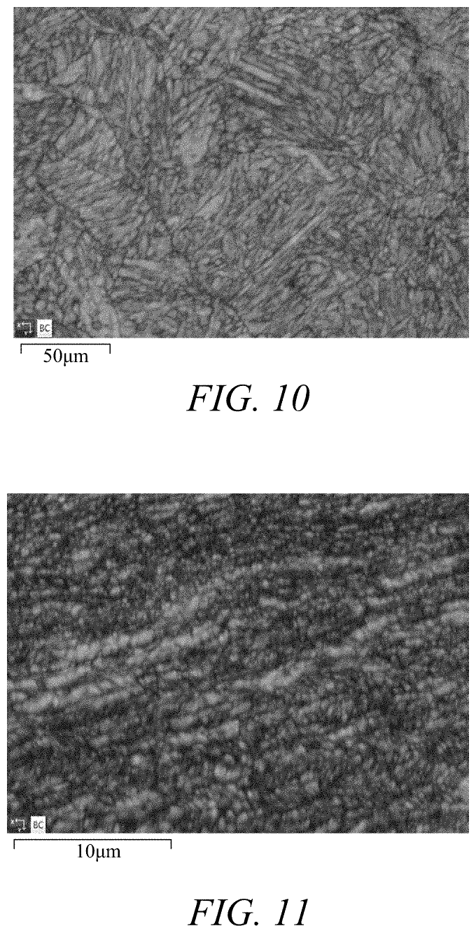

FIGS. 10 and 11 are optical images of the microstructure of maraging steel specimens that have been subjected, respectively, to conventional forging and flow-forming, followed by age-hardening. Note that these two optical images have an approximately five-fold difference in scale. The maraging steel used in these specimens has a low level of nickel, as disclosed above. As shown in FIG. 10, the microstructure of the conventionally forged specimen has a typical lath martensitic structure. By contrast, as shown in FIG. 11, the microstructure of the flow-formed specimen has a significant more refined microstructure.

Other incremental cold forming methods, such as those described above, may also be applied to maraging steels to achieve an increased strength compared with conventional forging. Ductility may be maintained.

The initial shape of the maraging steel blank may depend on the specific type of incremental cold forming operation 41 (or a sequence of such operations), and/or the target geometry of the component. For example, the maraging steel blank may be flat-shaped, cup-shaped, or tube-shaped. The shape of the maraging steel blank may follow a surface of revolution. The maraging steel blank may be of an any other arbitrary shape as required.

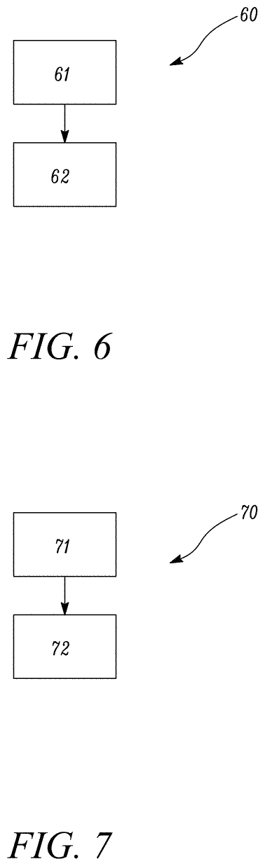

The maraging steel blank may be provided using any known industrial methods. FIGS. 5 and 6 depict processes for providing a maraging steel blank.

In FIG. 5, for example, a maraging steel stock may be provided 60, which may be further processed to provide the desired shape of the maraging steel blank. For example, the maraging steel stock may be machined 51 to the desired shape of the maraging steel blank. The maraging steel stock may be a bar, a forging, a tube, a welded wrapper, or an extrusion, for example.

Other methods may be used. For example, a maraging steel sheet stock may be cut or stamped to shape to provide a maraging steel blank 50, 70. Other methods, including deformational methods such as metal spinning, may be used to shape a maraging steel sheet stock to provide a maraging steel blank 50, 70. The deformational method used for providing the shape of the maraging steel blank may involve no reduction in thickness of the maraging steel sheet stock, or may involve a reduction in thickness.

The maraging steel blank may also be provided other than by processing a maraging steel stock. For example, the maraging steel blank may be cast into shape. The maraging steel blank may be provided by welding together smaller pieces of maraging steel. The maraging steel blank may be provided by an additive manufacturing technique.

As shown in FIG. 6, providing the maraging steel stock 60 may comprise heat treatment. The maraging steel stock may be heated up to transform the maraging steel into austenite 61, followed by quenching to produce a microstructure comprising martensite 62. The maraging steel stock may be heated up to and held at a temperature in the austenite region of the phase diagram of the maraging steel for a duration of time. The temperature and duration may be such that the transformation into austenite is complete. Quenching the maraging steel stock 62 may transform a majority of the austenite into martensite. Quenching may be performed by cooling in air, cooling in oil, cooling in water, or cooling in brine, for example. Other cooling media can be used for quenching.

Alternatively or additionally, as shown in FIG. 7, providing the maraging steel blank may comprise heat treatment 70. The maraging steel blank may be heated up to transform the maraging steel into austenite 71, followed by quenching to produce a microstructure comprising martensite 72. The maraging steel blank may be heated up to and held at a temperature in the austenite region of the phase diagram of the maraging steel for a duration of time. The temperature and duration may be such that the transformation into austenite is complete. Quenching the maraging steel blank 72 may transform a majority of the austenite into martensite. Quenching may be performed by cooling in air, cooling in oil, cooling in water, or cooling in brine, for example. Other cooling media can be used for quenching.

Ultra-high strength maraging steels may be difficult to machine in their fully-aged condition due to their high hardness (e.g. >500 HV), high ductility and/or toughness. After austenitisation (i.e. transforming into austenite 61, 71), maraging steels with lower levels of nickel, such as disclosed above, may have a relatively soft martensitic structure. These maraging steels may have a hardness of 350 HV or less. Using maraging steels with lower levels of nickel may facilitate machining, such as to provide a maraging steel blank.

The maraging steel blank may be provided using multiple stages of machining 51. Heat treatment 70 as described above may be applied between stages of machining 51. For example, the maraging steel blank may be provided by machining 51 a maraging steel stock in two stages: a rough machining stage and a final machining stage. The rough machining stage may impart a level of residual stress. Heat treatment 70 may be applied between the machining stages for stress relief, so as to facilitate the final machining stage.

The quenching 62, 72 may be performed such that the maraging steel fit, microstructure, before the incremental cold forming operation 41, contains retained austenite. The term ‘retained austenite_ refers to the typically small amount of austenite that is unable to transform into martensite during quenching 62, 72 because of the volume expansion associated with the formation of martensite in the microstructure. The presence of retained austenite is caused by a low martensite finish (Mf) temperature. At a given temperature, the transformation of austenite into martensite progresses until it becomes insufficiently thermodynamically favourable for further austenite to transform into martensite. As a consequence, an amount of ‘retained austenite remains.

As disclosed above, maraging steels with lower levels of nickel may exhibit less austenite reversion during age-hardening. However, after age-hardening, some retained austenite may still be present in the microstructure in these maraging steels.

The presence of retained austenite in the microstructure of a maraging steel may be detrimental to its physical properties, such as strength at elevated temperatures. The use of an incremental cold forming operation 41 on a maraging steel blank (after quenching), as a result of a reduction of thickness, may lead to a reduction in the amount of retained austenite. By reducing the amount of retained austenite, the physical properties of the maraging steel may be improved. For example, the properties at elevated temperature may be improved. For example, thermal stability may be improved. For example, creep performance may be improved. For example, a component manufactured using ‘Alloy 2_ as disclosed in US 2012/080124 A1 in conjunction with the method herein disclosed may have a service temperature in excess of 350éC.

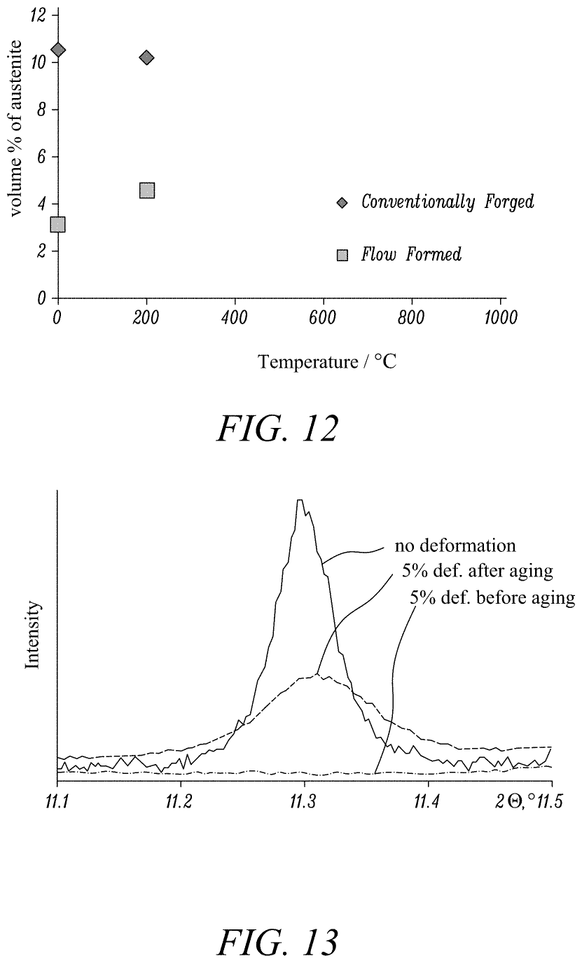

FIG. 12 shows measurements of the amount by volume % of retained austenite in specimens of ‘Alloy 2_, as measured using a synchrotron. As can be seen, flow forming (which is an example of incremental cold forming) results in a smaller amount of retained austenite compared with conventional forging. Furthermore, as the specimen is heated up, the amount of austenite reversion is less.

FIG. 13 shows measurements of the relative amount of retained austenite in specimens of ‘Alloy 2_, Three specimens are shown: one having undergone no deformation, one having been flow-formed after age-hardening, and one having been flow-formed before age-hardening. As can be seen, compared with the specimen having undergone no deformation, flow forming reduces the amount of retained austenite. Furthermore, flow forming before age-hardening results in less retained austenite compared with flow forming after age-hardening. As explained above, a reduction in the amount of retained austenite may result in improved physical properties such as temperature capability.

The improvements in physical properties in accordance with the present disclosure may be desirable in high-temperature applications such as components for gas turbine engines such as those discussed above. For example, as discussed above, where the fan 23 is attached to and driven by the low pressure turbine 19 via a shaft 26 and an epicyclic gearbox 30, the shaft 26 may be manufactured in accordance with the present disclosure. For example, as discussed above, where the high pressure turbine 17 drives the high pressure compressor 15 by a suitable IA interconnecting shaft 27, the interconnecting shaft 27 may be manufactured in accordance with the present disclosure. A gas turbine engine may comprise one or more components manufactured in accordance with the present disclosure.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

1. A method of manufacturing a component, the method comprising:
providing a maraging steel blank with an initial shape; and
performing an incremental cold forming operation on the maraging steel blank, wherein the incremental cold forming operation reduces a thickness of the maraging steel blank.

2. The method as claimed in claim 1, wherein the incremental cold forming operation is performed with the maraging steel blank at an initial temperature below the recrystallisation temperature of the maraging steel, optionally at room temperature.

3. The method as claimed in claim 1, wherein the incremental cold forming operation reduces the thickness of the maraging steel blank by at least 20%.

4. The method as claimed in claim 1, wherein the incremental cold forming operation comprises at least one of a flow-forming operation, a shear-forming operation, and a cold rotary forging operation.

5. The method as claimed in claim 1, further comprising performing an age-hardening operation on the component after the incremental cold forming operation.

6. The method as claimed in claim 5, wherein the age-hardening operation is performed with the component at a temperature of at least 400° C.

7. The method as claimed in claim 5, wherein the age-hardening operation is performed for a duration of 3 to 25 hours.

8. The method as claimed in claim 1, wherein, before performing the incremental cold forming operation, the initial shape of the maraging steel blank is flat-shaped, cup-shaped, or tube-shaped.

9. The method as claimed in claim 1, wherein providing the maraging steel blank comprises:
providing a maraging steel stock; and
machining the maraging steel stock to the initial shape of the maraging steel blank.

10. The method as claimed in claim 9, wherein the maraging steel stock is a bar, a forging, a tube, a welded wrapper, or an extrusion.

11. The method as claimed in claim 9, wherein providing the maraging steel stock comprises:
transforming the maraging steel of maraging steel stock into austenite by heating; and
quenching the maraging steel stock to form a maraging steel microstructure comprising martensite.

12. The method as claimed in claim 1, wherein providing maraging steel blank comprises:
transforming the maraging steel of maraging steel blank into austenite by heating; and
quenching the maraging steel blank to form a maraging steel microstructure comprising martensite.

13. The method as claimed in claim 11, wherein the quenching is performed such that the maraging steel microstructure, before the incremental cold forming operation, comprises retained austenite.

14. A component manufactured using the method as claimed in claim 1.

15. A gas turbine engine for an aircraft comprising:
an engine core comprising a turbine, a compressor, and a core shaft connecting the turbine to the compressor;
a fan located upstream of the engine core, the fan comprising a plurality of fan blades; and
a gearbox that receives an input from the core shaft and outputs drive to the fan so as to drive the fan at a lower rotational speed than the core shaft,
wherein the gas turbine engine comprises a component manufactured using the method as claimed in claim 1.

16. The gas turbine engine as claimed in claim 15, wherein:
the turbine is a first turbine, the compressor is a first compressor, and the core shaft is a first core shaft;
the engine core further comprises a second turbine, a second compressor, and a second core shaft connecting the second turbine to the second compressor; and
the second turbine, second compressor, and second core shaft are arranged to rotate at a higher rotational speed than the first core shaft.

17. The gas turbine engine as claimed in claim 15, wherein the core shaft is manufactured using a method of manufacturing a component comprising:
providing a maraging steel blank with an initial shape; and
performing an incremental cold forming operation on the maraging steel blank, wherein the incremental cold forming operation reduces a thickness of the maraging steel blank.

18. The gas turbine engine of claim 16, wherein one or both of the first and second core shafts is manufactured using a method of manufacturing a component comprising:
providing a maraging steel blank with an initial shape; and
performing an incremental cold forming operation on the maraging steel blank, wherein the incremental cold forming operation reduces a thickness of the maraging steel blank.
